(19) United States
(12) Patent Application Publication
(10) Pub. No.: US 2017/0147513 A1
(43) Pub. Date: May 25, 2017

(54) MULTIPLE PROCESSOR ACCESS TO SHARED PROGRAM MEMORY

(71) Applicant: KNUEDGE, INC., San Diego, CA (US)

(72) Inventors: Robert Nicholas Hilton, San Diego, CA (US); William Christensen Clevenger, San Diego, CA (US); Jerome V. Coffin, San Diego, CA (US)

(73) Assignee: KNUEDGE, INC., San Diego, CA (US)

(21) Appl. No.: 14/950,807

(22) Filed: Nov. 24, 2015

(51) Int. Cl. G06F 13/16; G06F 13/40; G06F 3/06

(52) U.S. Cl. CPC G06F 13/1663; G06F 3/0604; G06F 3/061; G06F 3/0638; G06F 3/0673; G06F 13/4068

(57) ABSTRACT

A shared program memory and related components configured to distribute data from a memory block to multiple processors at the same time. An arbiter determines what processors are requesting data from the same memory locations. Data from that memory location is then accessed and sent to the requesting processors so that the data arrives at about the same time to each processor, for example, during the same clock cycle. Such distribution is made possible using a configuration such as a shared data bus with corresponding valid bits for each register or using a multicaster and separate data busses for each processor.

### BACKGROUND

Multi-processor computer architectures capable of parallel computing operations were originally developed for supercomputers. Today, with modern microprocessors containing multiple processor “cores,” the principles of parallel computing have become relevant to both on-chip and distributed computing environment.

### BRIEF DESCRIPTION OF DRAWINGS

For a more complete understanding of the present disclosure, reference is now made to the following description taken in conjunction with the accompanying drawings.

FIG. 1 is a block diagram conceptually illustrating an example of a network-on-a-chip architecture that supports multiple processor access to shared program memory.

FIG. 2 is a block diagram conceptually illustrating example components of a processing element of the architecture in FIG. 1.

FIG. 3 illustrates a prior art example of shared memory caching.

FIG. 4A illustrates a prior art example of shared memory access for specific memory tiles.

FIG. 4B illustrates timing of the prior art example of shared memory access for specific memory tiles.

FIG. 5A illustrates an example of a chip configuration for allowing multiple processor access to shared program memory according to one aspect of the present disclosure.

FIG. 5B illustrates a chip configuration for allowing multiple processor access to shared program memory according to one aspect of the present disclosure.

FIG. 6 illustrates a chip configuration for allowing multiple processor access to shared program memory according to one aspect of the present disclosure.

FIG. 7 illustrates a chip configuration for allowing multiple processor access to shared program memory according to one aspect of the present disclosure.

FIG. 8 illustrates a process for allowing multiple processor access to shared program memory according to one aspect of the present disclosure.

### DETAILED DESCRIPTION

In a network on a chip processor, it is common for a number of processing elements to share access to a common memory, such as for program code and/or data shared between the processing elements. It is also common for processing elements to synchronize at times. Following such synchronization, the processing elements frequently re-start execution from the same point in the shared memory. When this re-start takes place, a number of processing elements will often attempt to read the same data from the same location to retrieve the next instructions each needs to execute. In such a case, the memory can form a bottleneck as the same data is repeatedly retrieved. This bottleneck will result in individual processors being delayed from access the desired memory location and thus will cause undesired processing delays. There is, therefore, a need for a network on a chip with a memory shared between processing elements to minimize the delay when processing elements need access to the same locations, such as when execution is restarted following synchronization. Offered are a number of chip configurations allowing simultaneous (i.e., within the same clock cycle) or substantially simultaneous (i.e., within a few clock cycles) access to data stored in memory to multiple different processing elements.

In one example, a component such as comparator may be added to a chip configuration to determine when multiple processors are requesting access to the same memory address. In such a case, a broadcast mask may be constructed at the memory output to distribute the data from the memory address to the corresponding requesting processing elements. The requested address is read from the memory, and the result is broadcast to all the requesting processing elements substantially simultaneously. In this manner, data is obtained from the memory using a single memory read operation and distributed to multiple recipients, rather than a series of read operations (each requiring its own multiple clock cycles) needed to send the same data to multiple recipients. Other configurations, such as those disclosed below, are also possible. In this manner, distributing the same program data to multiple processors is made significantly more efficient.

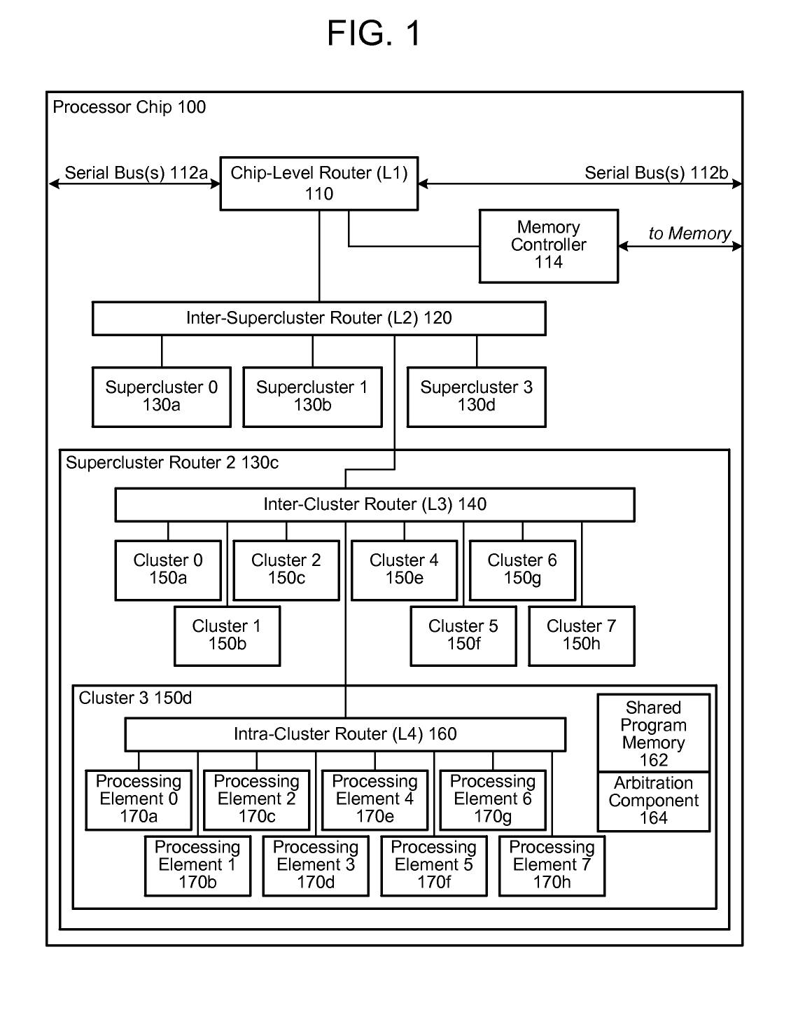

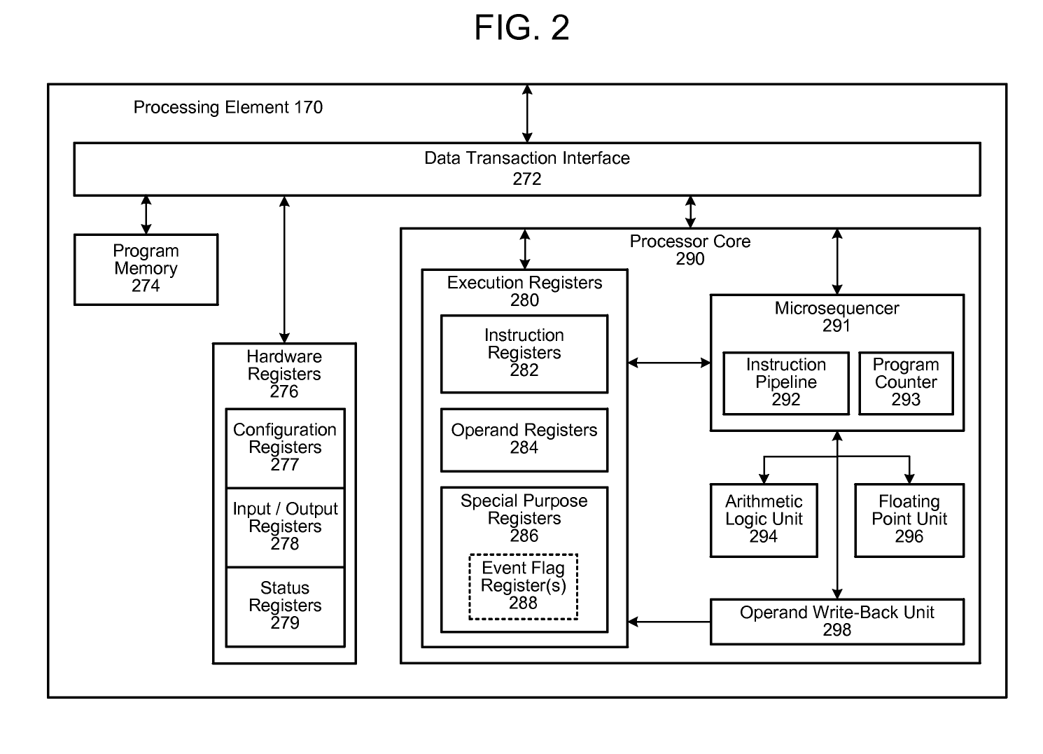

FIG. 1 is a block diagram conceptually illustrating an example of a network-on-a-chip architecture that supports substantially simultaneous distribution of program data to multiple processor elements. A processor chip 100 may be composed of a large number of processing elements 170 (e.g., 256 processing elements), connected together on chip via a switched or routed fabric similar to what is typically seen in a computer network. FIG. 2 is a block diagram conceptually illustrating example components of a processing element 170 of the architecture in FIG. 1.

Each processing element 170 may have direct access to some (or all) of the operand registers 284 of the other processing elements, such that each processing element 170 may read and write data directly into operand registers 284 used by instructions executed by the other processing element, thus allowing the processor core 290 of one processing element to directly manipulate the operands used by another processor core for opcode execution.

An “opcode” instruction is a machine language instruction that specifies an operation to be performed by the executing processor core 290. Besides the opcode itself, the instruction may specify the data to be processed in the form of operands. An address identifier of a register from which an operand is to be retrieved may be directly encoded as a fixed location associated with an instruction as defined in the instruction set (i.e. an instruction permanently mapped to a particular operand register), or may be a variable address location specified together with the instruction.

Each operand register 284 may be assigned a global memory address comprising an identifier of its associated processing element 170 and an identifier of the individual operand register 284. The originating processing element 170 of the read/write transaction does not need to take special actions or use a special protocol to read/write to another processing element's operand register, but rather may access another processing element's registers as it would any other memory location that is external to the originating processing element. Likewise, the processing core 290 of a processing element 170 that contains a register that is being read by or written to by another processing element does not need to take any action during the transaction between the operand register and the other processing element.

Conventional processing elements commonly include two types of registers: those that are both internally and externally accessible, and those that are only internally accessible. The hardware registers 276 in FIG. 2 illustrate examples of conventional registers that are accessible both inside and outside the processing element, such as configuration registers 277 used when initially “booting” the processing element, input/output registers 278, and various status registers 279. Each of these hardware registers are globally mapped, and are accessed by the processor core associated with the hardware registers by executing load or store instructions.

The internally accessible registers in conventional processing elements include instruction registers and operand registers, which are internal to the processor core itself. These registers are ordinarily for the exclusive use of the core for the execution of operations, with the instruction registers storing the instructions currently being executed, and the operand registers storing data fetched from hardware registers 276 or other memory as needed for the currently executed instructions. These internally accessible registers are directly connected to components of the instruction execution pipeline (e.g., an instruction decode component, an operand fetch component, an instruction execution component, etc.), such that there is no reason to assign them global addresses. Moreover, since these registers are used exclusively by the processor core, they are single “ported,” since data access is exclusive to the pipeline.

In comparison, the execution registers 280 of the processor core 290 in FIG. 2 may each be dual-ported, with one port directly connected to the core's micro-sequencer 291, and the other port connected to a data transaction interface 272 of the processing element 170, via which the operand registers 284 can be accessed using global addressing. As dual-ported registers, data may be read from a register twice within a same clock cycle (e.g., once by the micro-sequencer 291, and once by the data transaction interface 272).

Communication between processing elements 170 may be performed using packets, with each data transaction interface 272 connected to one or more busses, where each bus comprises at least one data line. Each packet may include a target register's address (i.e., the address of the recipient) and a data payload. The busses may be arranged into a network, such as the hierarchical network of busses illustrated in FIG. 1. The target register's address may be a global hierarchical address, such as identifying a multicore chip 100 among a plurality of interconnected multicore chips, a supercluster 130 of core clusters 150 on the chip, a core cluster 150 containing the target processing element 170, and a unique identifier of the individual operand register 284 within the target processing element 170.

For example, referring to FIG. 1, each chip 100 may include four superclusters 130a-130d, each supercluster 130 comprises eight clusters 150a-150h, and each cluster 150 may comprise eight processing elements 170a-170h. If each processing element 170 includes two-hundred-fifty six operand registers 284, then within the chip 100, each of the operand registers may be individually addressed with a sixteen bit address: two bits to identify the supercluster, three bits to identify the cluster, three bits to identify the processing element, and eight bits to identify the register. The global address may include additional bits, such as bits to identify the processor chip 100, such that processing elements 170 may directly access the registers of processing elements across chips. The global addresses may also accommodate the physical and/or virtual addresses of a main memory accessible by all of the processing elements 170 of a chip 100, tiered memory locally shared by the processing elements 170 (e.g., cluster memory 162), etc. Whereas components external to a processing element 170 addresses the registers 284 of another processing element using global addressing, the processor core 290 containing the operand registers 284 may instead uses the register's individual identifier (e.g., eight bits identifying the two-hundred-fifty-six registers).

Other addressing schemes may also be used, and different addressing hierarchies may be used. Whereas a processor core 290 may directly access its own execution registers 280 using address lines and data lines, communications between processing elements through the data transaction interfaces 272 may be via a variety of different bus architectures. For example, communication between processing elements and other addressable components may be via a shared parallel bus-based network (e.g., busses comprising address lines and data lines, conveying addresses via the address lines and data via the data lines). As another example, communication between processing elements and other components may be via one or more shared serial busses.

Addressing between addressable elements/components may be packet-based, message-switched (e.g., a store-and-forward network without packets), circuit-switched (e.g., using matrix switches to establish a direct communications channel/circuit between communicating elements/components), direct (i.e., end-to-end communications without switching), or a combination thereof. In comparison, to message-switched, circuit-switched, and direct addressing, a packet-based conveys a destination address in a packet header and a data payload in a packet body via the data line(s).

As an example of an architecture using more than one bus type and more than one protocol, inter-cluster communications may be packet-based via serial busses, whereas intra-cluster communications may be message-switched or circuit-switched using parallel busses between the intra-cluster router (L4) 160, the processing elements 170a to 170h within the cluster, and other intra-cluster components (e.g., cluster memory 162). In addition, within a cluster, processing elements 170a to 170h may be interconnected to shared resources within the cluster (e.g., cluster memory 162) via a shared bus or multiple processing-element-specific and/or shared-resource-specific busses using direct addressing (not illustrated).

The source of a packet is not limited only to a processor core 290 manipulating the operand registers 284 associated with another processor core 290, but may be any operational element, such as a memory controller 114, a data feeder (not shown), an external host processor connected to the chip 100, a field programmable gate array, or any other element communicably connected to a processor chip 100 that is able to communicate in the packet format.

The data feeder may execute programmed instructions which control where and when data is pushed to the individual processing elements 170. The data feeder may also be used to push executable instructions to the program memory 274 of a processing element 170 for execution by that processing element's instruction pipeline. The data feeder may also operate in conjunction with the arbitration component 164, discussed further below.

In addition to any operational element being able to write directly to an operand register 284 of a processing element 170, each operational element may also read directly from an operand register 284 of a processing element 170, such as by sending a read transaction packet indicating the global address of the target register to be read, and the global address of the destination address to which the reply including the target register's contents is to be copied.

A data transaction interface 272 associated with each processing element may execute such read, write, and reply operations without necessitating action by the processor core 290 associated with an accessed register. Thus, if the destination address for a read transaction is an operand register 284 of the processing element 170 initiating the transaction, the reply may be placed in the destination register without further action by the processor core 290 initiating the read request. Three-way read transactions may also be undertaken, with a first processing element 170x initiating a read transaction of a register located in a second processing element 170y, with the destination address for the reply being a register located in a third processing element 170z.

Memory within a system including the processor chip 100 may also be hierarchical. Each processing element 170 may have a local program memory 274 containing instructions that will be fetched by the micro-sequencer 291 in accordance with a program counter 293. Processing elements 170 within a cluster 150 may also share a program memory 162, such as a shared memory serving a cluster 150 including eight processor cores 290. While a processor core 290 may experience no latency (or a latency of one-or-two cycles of the clock controlling timing of the instruction pipeline 292) when accessing its own execution registers 280, accessing global addresses external to a processing element 170 may experience a larger latency due to (among other things) the physical distance between processing elements 170. As a result of this additional latency, the time needed for a processor core to access an external main memory, a shared program memory 162, and the registers of other processing elements may be greater than the time needed for a core 290 to access its own program memory 274 and execution registers 280.

Data transactions external to a processing element 170 may be implemented with a packet-based protocol carried over a router-based or switch-based on-chip network. The chip 100 in FIG. 1 illustrates a router-based example. Each tier in the architecture hierarchy may include a router. For example, in the top tier, a chip-level router (L1) 110 routes packets between chips via one or more high-speed serial busses 112a, 112b, routes packets to-and-from a memory controller 114 that manages primary general-purpose memory for the chip, and routes packets to-and-from lower tier routers.

The superclusters 130a-130d may be interconnected via an inter-supercluster router (L2) 120 which routes transactions between superclusters and between a supercluster and the chip-level router (L1) 110. Each supercluster 130 may include an inter-cluster router (L3) 140 which routes transactions between each cluster 150 in the supercluster 130, and between a cluster 150 and the inter-supercluster router (L2). Each cluster 150 may include an intra-cluster router (L4) 160 which routes transactions between each processing element 170 in the cluster 150, and between a processing element 170 and the inter-cluster router (L3). The level 4 (L4) intra-cluster router 160 may also direct packets between processing elements 170 of the cluster and a cluster memory 162. Tiers may also include cross-connects (not illustrated) to route packets between elements in a same tier in the hierarchy. A processor core 290 may directly access its own operand registers 284 without use of a global address.

Memory of different tiers may be physically different types of memory. Operand registers 284 may be a faster type of memory in a computing system, whereas as external general-purpose memory typically may have a higher latency. To improve the speed with which transactions are performed, operand instructions may be pre-fetched from slower memory and stored in a faster program memory (e.g., program memory 274 in FIG. 2) prior to the processor core 290 needing the operand instruction.

Referring to FIG. 2, a micro-sequencer 291 of the processor core 290 may fetch a stream of instructions for execution by the instruction pipeline 292 in accordance with a memory address specified by a program counter 293. The memory address may be a local address corresponding to an address in the processing element's own program memory 274. In addition to or as an alternative to fetching instructions from the local program memory 274, the program counter 293 may be configured to support the hierarchical addressing of the wider architecture, generating addresses to locations that are external to the processing element 170 in the memory hierarchy, such as a global address that results in one or more read requests being issued to a cluster memory 162, to a program memory 274 within a different processing element 170, to a main memory (not illustrated, but connected to memory controller 114 in FIG. 1), to a location in a memory on another processor chip 100 (e.g., via a serial bus 112), etc. The micro-sequencer 291 also controls the timing of the instruction pipeline 292.

The program counter 293 may present the address of the next instruction in the program memory 274 to enter the pipeline for execution, with the instruction fetched by the micro-sequencer 291 in accordance with the presented address. The microsequencer 291 utilizes the instruction registers 282 for instructions being processed by the instruction pipeline 292. After the instruction is read on the next clock cycle of the system clock, the program counter may be incremented. A stage of the instruction pipeline 292 may decode the next instruction to be executed, and instruction registers 282 may be used to store the decoded instructions. The same logic that implements the decode stage may also present the address(es) of the operand registers 284 of any source operands to be fetched.

An operand instruction may require zero, one, or more source operands. The source operands may be fetched from the operand registers 284 by an operand fetch stage of the instruction pipeline 292 and presented to an arithmetic logic unit (ALU) 294 of the processor core 290 on the next clock cycle. The arithmetic logic unit (ALU) may be configured to execute arithmetic and logic operations using the source operands. The processor core 290 may also include additional component for execution of operations, such as a floating point unit 296. Complex arithmetic operations may also be sent to and performed by a component or components shared among processing elements 170a-170h of a cluster via a dedicated high-speed bus, such as a shared component for executing floating-point divides (not illustrated).

An instruction execution stage of the instruction pipeline 292 may cause the ALU 294 (and/or the FPU 296, etc.) to execute the decoded instruction. Execution by the ALU 294 may require a single cycle of the system clock, with extended instructions requiring two or more. Instructions may be dispatched to the FPU 296 and/or shared component(s) for complex arithmetic operations in a single clock cycle, although several cycles may be required for execution. If an operand write will occur, an address of a register in the operand registers 284 may be set by an operand write stage of the execution pipeline 292 contemporaneous with execution.

After execution, the result may be received by an operand write stage of the instruction pipeline 292 for write-back to one or more registers 284. The result may be provided to an operand write-back unit 296 of the processor core 290, which performs the write-back, storing the data in the operand register(s) 284. Depending upon the size of the resulting operand and the size of the registers, extended operands that are longer than a single register may require more than one clock cycle to write.

Register forwarding may also be used to forward an operand result back into the execution stage of a next or subsequent instruction in the instruction pipeline 292, to be used as a source operand execution of that instruction. For example, a compare circuit may compare the register source address of a next instruction with the register result destination address of the preceding instruction, and if they match, the execution result operand may be forwarded between pipeline stages to be used as the source operand for execution of the next instruction, such that the execution of the next instructions does not need to fetch the operand from the registers 284.

To preserve data coherency, a portion of the operand registers 284 being actively used as working registers by the instruction pipeline 292 may be protected as read-only by the data transaction interface 272, blocking or delaying write transactions that originate from outside the processing element 170 which are directed to the protected registers. Such a protective measure prevents the registers actively being written to by the instruction pipeline 292 from being overwritten mid-execution, while still permitting external components/processing elements to read the current state of the data in those protected registers.

As shown in FIG. 1, an individual cluster may have a shared program memory 162 connected to an arbitration component 164. As noted above, certain processing elements 170 may request simultaneous access to certain memory addresses. The arbitration component 164 may coordinate such address requests, access the particular address using the shared program memory 164, and distribute the data at the address to the requesting processing elements 170. The arbitration component 164 may include a number of different components, such as the arbiter 530, scanner 650, multicaster(s) 660, or other components discussed below to implement substantial simultaneous distribution of program data as discussed below. The implementations of the arbitration component 164 discussed herein differ from current shared memory configurations as discussed below.

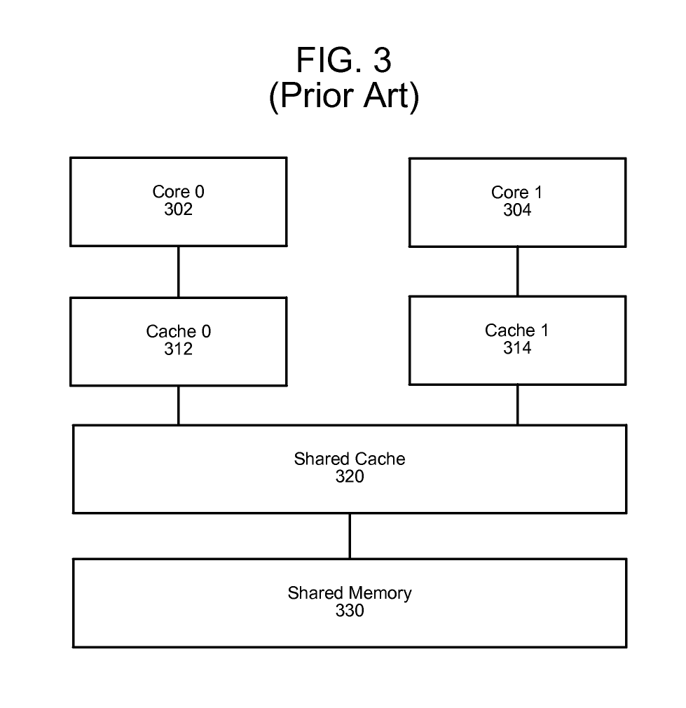

FIG. 3 illustrates a typical prior art shared memory configuration. In this configuration, two processor cores, 302 and 304 are configured to share the data in shared memory 330. Data from the shared memory 330 may be transferred to the shared cache 320. The individual cores 302 and 304 will then pull data from the shared cache 320 into the respective individual caches 312 and 314 so that each processor may individually have access to desired data in its individual cache. As a result of this construction, multiple items of data may be stored in multiple locations, resulting in an inefficient allocation of memory resources. Further, large caches (such as shared cache 320 or individual caches 312 and 314) require additional transistors, chip space, etc.

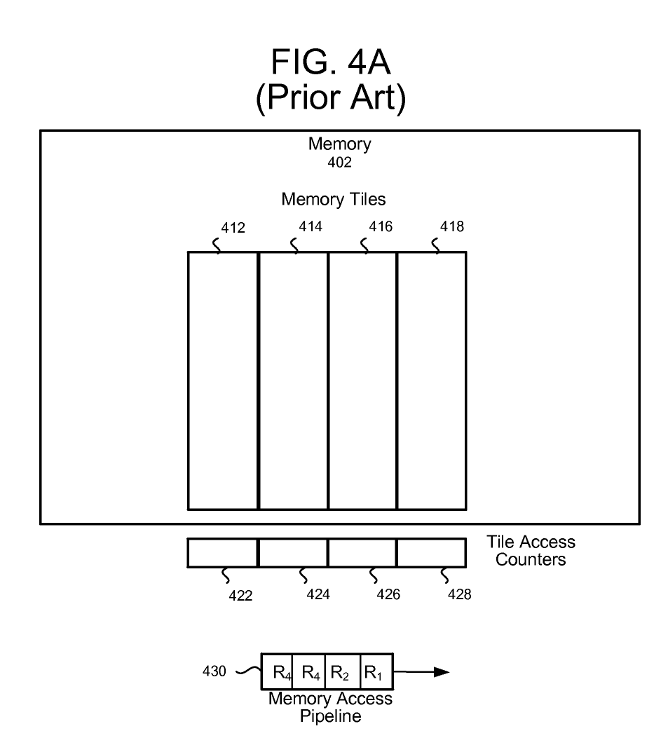

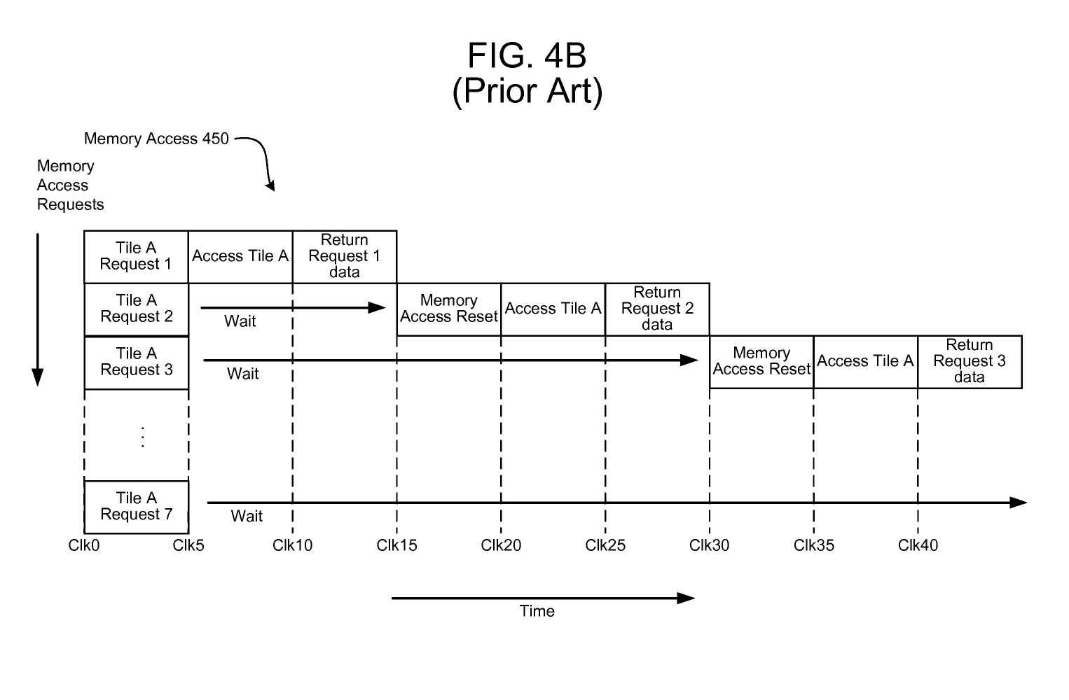

In another prior art shared memory configuration, shown in FIG. 4A, a shared memory 402 may include data at certain locations that multiple processors wish to access at the same time. Current systems, however, are not equipped to efficiently handle such requests. This is due to a number of constraints, in particular the constraint that current memory blocks do not allow simultaneous access to the same memory address or group of addresses. Memories may impose a minimum time between repeated accesses to the same memory location. This minimum time is often 5 to 10 times longer than a processing element's clock cycle time (and may be considerably more than 10 times longer). For example, if a processor is running at 1 GHz, but a memory can only process requests at 250 MHz, this can lead to substantial delays in processing. For example, in a typical memory a single access to a particular memory location might require 5 clock cycles, and then there is a 10 cycle wait before that same location can be accessed again. If, for example, 16 processing elements share access to the same memory, and all are requesting execution of the same instructions (whose data is located at the same locations in a memory), the first element may wait only 5 cycles, but the second waits 20 cycles, the third 35 cycles, and so on up to the last waiting approximately 240 cycles before it can begin execution.

For example, a memory, such as memory 402 may include a number of memory tiles 412-418. Incoming memory requests are gathered in a memory access pipeline 430, illustrated as showing requests R₁-R₄. The first incoming request R₁ is processed to access the requesting memory tile. The system also tracks the clock cycles since each particular tile is accessed using tile access counters 422-428. If R₁ requests an address in tile 412, the tile access counter 422 is set and then does not allow access to tile 412 until a sufficient amount of time has passed. This wait time varies between memories but may be several clock cycles (e.g. 5-10). Thus, if requests R₂ also requests access to memory tile 412, it will need to wait until those clock cycles have completed before accessing the memory. As can be appreciated, if requests R₃ requests and R₄ are also requesting access to tile 412, their waits will be multiple times the wait of R₂.

An example of these delays is illustrated in FIG. 4B. Assuming a set of 8 processors (numbered 0-7) all request access to the same tile at the same time, namely at clock cycles 0-5. The requests may be handled only one at a time. During clock cycles 5-10, tile A is accessed for request 1 and the data is returned during clock cycles 10-15. During clocks 15-20, the memory access may reset, after which tile A may be accessed again (during clocks 20-25) to return the data to the second processor for request 2 (during clocks 25-30). During these times the remaining processors (3-7) are idle and waiting on the memory to complete the request. As can be appreciated, these times grow with the number of requesting processing elements.

Even further, however, in certain situations a memory access pipeline 430, will only allow a requests that involve different memory tiles, meaning that if an incoming request is attempting to access the same tile as any of the four requests in the pipeline, the incoming request may be rejected and may need to wait until the pipeline clears. Thus even more delays may be introduced to the system.

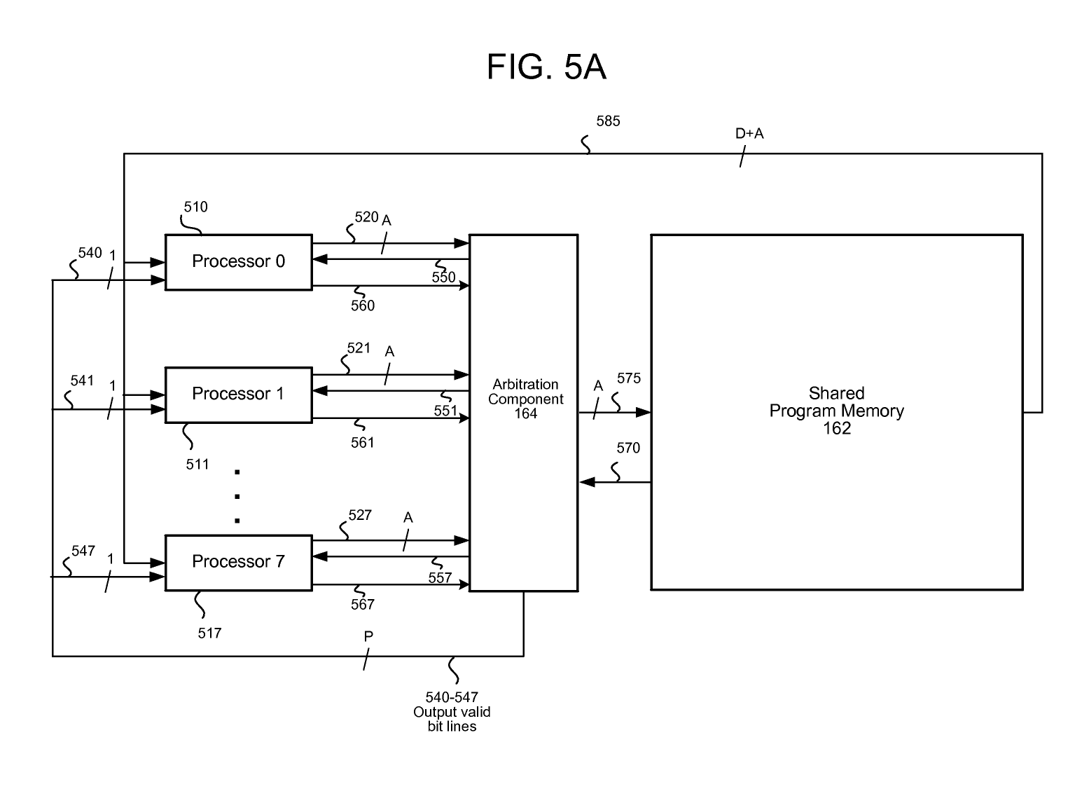

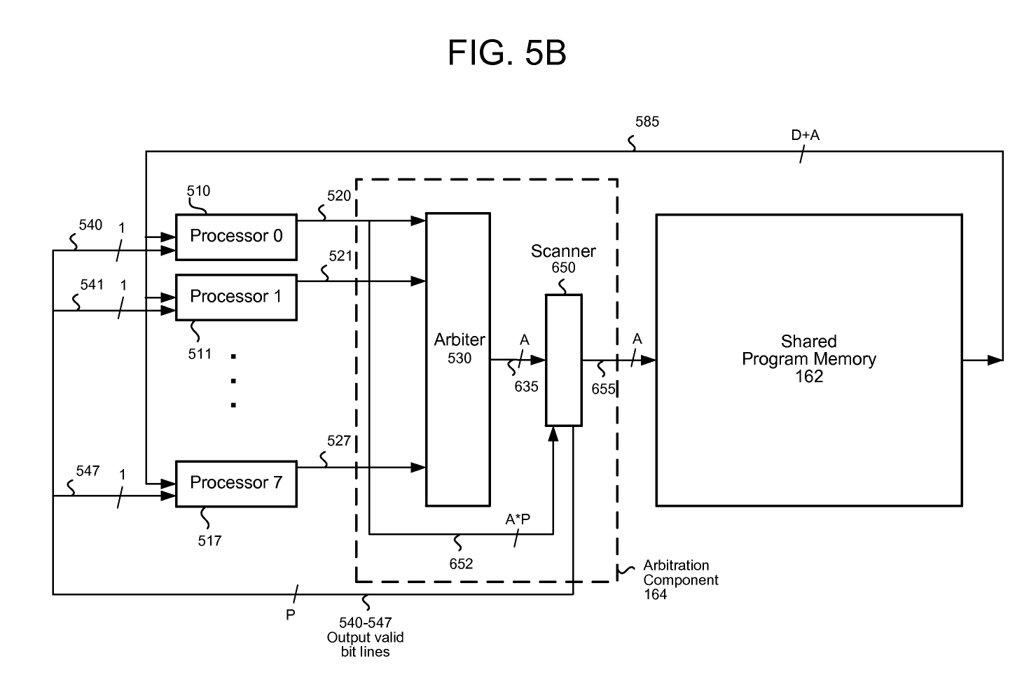

Such delays are generally undesirable, and particularly undesirable under certain circumstances. For example, during a system reset, processors may wish to perform a synchronization or other “boot-up” type of activity where each processor may wish to execute a same program instruction at or around the same time. The program instruction may be stored at a single location in shared memory, for example in shared program memory 162. Offered are chip configurations and methods to provide the program instruction to the requesting processors in a substantially simultaneous manner. One such configuration is shown in FIG. 5A.

FIG. 5A illustrates an example of a chip configuration for allowing multiple processor access to shared program memory according to one aspect of the present disclosure. As shown in FIG. 5A, a number of processors, processor 0 through processor 7 (510 through 517) are connected to an arbitration component 164. Although eight processors are illustrated, the configuration of FIG. 5A may apply to a different number of processors, as may the configurations of FIGS. 5B-7 discussed below. The processors 510-517 may be individual processing elements 170, specific processor cores 290, or other processor-type components. Each processor is connected to the arbitration component 164 using a number of lines. Lines 520-527 are address lines that are used to indicate to the arbitration component 164 the desired address in the shared program memory 162 each particular processor wishes to access. The “/A” on each of these address lines indicates that the lines include sufficient bits to indicate the particular address, which may vary depending on chip configuration. Each processor is also connected to the arbitration component 164 using a request valid bit line 560-567. These request valid bit lines are used to indicate to the arbitration component 164 which processors are actively requesting to access the memory 162 using the their respective address lines.

The arbitration component 164 may check the request valid bit lines 560-567 to determine which of the request valid bit lines are active at any particular time. The arbitration component 164 may determine which address to select as the “base” address from which to compare to the other active addresses in a number of ways. The arbitration component 164 may proceed in order, that is start with processor 0 510 to see if processor 0's request valid bit line is high, and if it is not, proceed to processor 1 511, and so on. When a request valid bit line is high, the arbitration component 164 may take the address indicated on that processor's address line as the base address and may compare other addresses to that address. The arbitration component 164 may also go in reverse order, i.e., start at processor 7 and go to processor 0 to obtain a base address. The arbitration component 164 may also go in round-robin fashion, starting with a certain processor during one memory access cycle and starting with another processor during another memory access cycle. Other techniques for determining a base address may also be used. The task for determining which processor's request will be selected for purposes of accessing the memory may be performed by a component such as an arbiter, illustrated in FIG. 5B.

The arbitration component 164 may also be configured with comparator circuitry that can compare the address lines 520-527 for the processors whose request valid bit lines are active (high) at any particular time (i.e., clock cycle). The arbitration component 164 may compare other active request addresses to the base address to determine which processor(s) are also requesting the base address. The comparison may be performed by one or more comparator components, for example a scanner 650 illustrated in FIG. 5B. The scanner 650 may receive the address selected by the arbiter 530 across line 635. The scanner 650 will then send that requested address to the shared program memory 162 on line 655. The scanner 650 will also receive the addresses requested by each of the processors 510-517 over address lines 652, where 652 represents a set of P address lines, where P corresponds to the number of processors and A corresponds to the number of address bits of the system. The scanner 650 will then compare the addresses indicated on lines 652 with the address indicated on line 635. The scanner 650 may include a number of comparators for this purpose. For each processor whose requested address matches the priority address from the arbiter 530 (i.e., on line 635), the scanner will eventually set the corresponding bit on indicator lines 540-547 corresponding to the respective processor 510-517, although the scanner will wait to set the appropriate lines from 540-547 until the data corresponding to the requested address is output by the shared program memory 162 onto data bus 585, as described below.

Returning to FIG. 5A for purposes of further illustration, the arbitration component 164 may activate the acknowledgement bit lines (550-557) for the processors that are requesting the same address. For example, if processors 0, 3, and 4 are all requesting to access the same memory address that is selected by the arbitration component 164, the arbitration component 164 may set acknowledgement bit lines 550, 553, and 554. The arbitration component 164 may also have a valid line (not shown) to indicate when it (or a corresponding pipeline, discussed below) has a request waiting. The arbitration component 164 may then indicate the requested address to the shared program memory 162 over address line 575 (which may be the same as line 635/655 depending on system configuration). The memory 162 may then acknowledge the request to the arbitration component 164 using acknowledgement line 570, thus indicating that the memory will retrieve data in that address. Acknowledgement line 570 to the arbitration component 164 may be used by the arbitration component 164 to set the appropriate acknowledgement bit lines 550-557 to acknowledge to the processors requesting the shared address that their requests are being processed. The memory 162 may access the requested memory location and output the data corresponding to the memory location onto data bus 585. As indicated by the “/D+A,” the data bus includes the number of bits corresponding to the data line, which may vary depending on chip location, as well as a number of bits to communicate a memory address (i.e., an address line). The address bits are used to inform the receiving processor of the address from which the data came. Using the address bits, the receiving processor can confirm that the data on the data bus 585 corresponds to the address requested by the processor. In certain implementations, however, the data bus 585 may only include D bits as the timing of the operations may be used to determine when the data on the bus is intended for a particular processor. The data bus 585 is illustrated as a shared data bus that connects to each processor 510-517. When the data corresponding to the requested address is active on the data bus 585, the arbitration component 164 may set the output valid bit lines (540-547) corresponding to the requesting processors. As illustrated by the “/P” in FIG. 5A, which represents the number of processors, the number of output valid bit lines corresponds to the number of processors. Again, in the example where processors 0, 3, and 4 are all requesting to access the same memory address that is selected by the arbitration component 164, when the data corresponding to that address is on the data bus 585, the arbitration component 164 will set output valid bit lines 540, 543, and 544. When the appropriate output valid bit lines are high, the individual processors know that the data on the data bus is intended for them and may access and process that data.

As can be appreciated, the circuitry (either in the arbitration component, 164, shared program memory 162, or otherwise) may include a pipeline to store memory access requests/addresses in order. The pipeline may function similarly to the pipeline of FIG. 4A. During each clock cycle (or every few clock cycles), a new address at the end of the pipeline may be output to the shared memory to retrieve data, while a new address corresponding to the requesting processor(s) may be added to the beginning of the pipeline. The acknowledgement lines 550-557 and 570 may be connected to the pipeline. As can also be appreciated, certain delay circuitry may be incorporated into the chip of FIG. 5A, to account for delays in comparing addresses, passing an address to the memory 162, performing memory access, loading data, pipeline loading/output, etc. The delay circuitry (not illustrated) may ensure proper operation of the chip, for example, ensuring that the proper data is on the data bus 585 when the appropriate output valid bit lines are set. Such pipeline circuitry and/or delay circuitry may also be present in the configurations of FIGS. 5B-7 discussed below.

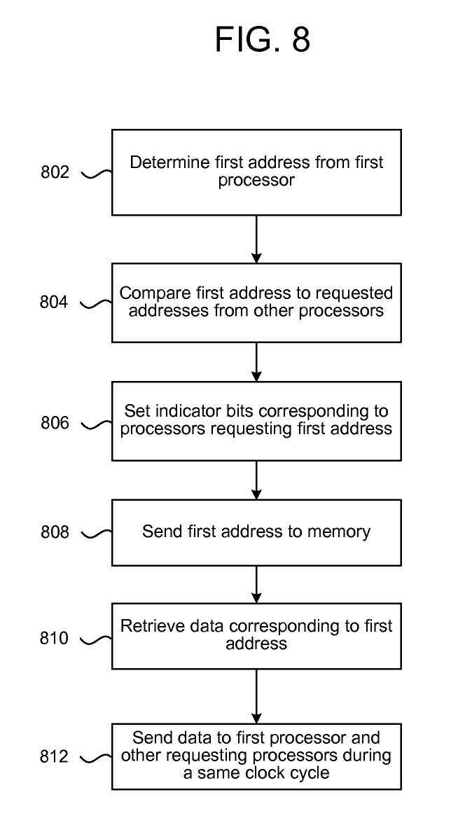

As can also be appreciated, the configuration of FIG. 5A will result in each processor that requests data from a same address getting access to the data corresponding to that address during the same clock (or nearly the same) clock cycle, depending on activation of the output valid bit lines 540-547. If the appropriate valid bit lines are activated at the same time (as is envisioned by the circuit of FIG. 5A), then the data will be delivered during the same clock cycle to the appropriate processors, thus significantly reducing the delays found in the prior art discussed above. This simultaneous, or substantially simultaneous delivery of the same data to multiple processors may also be achieved using the configurations of FIGS. 5B-7 or method of FIG. 8 discussed below.

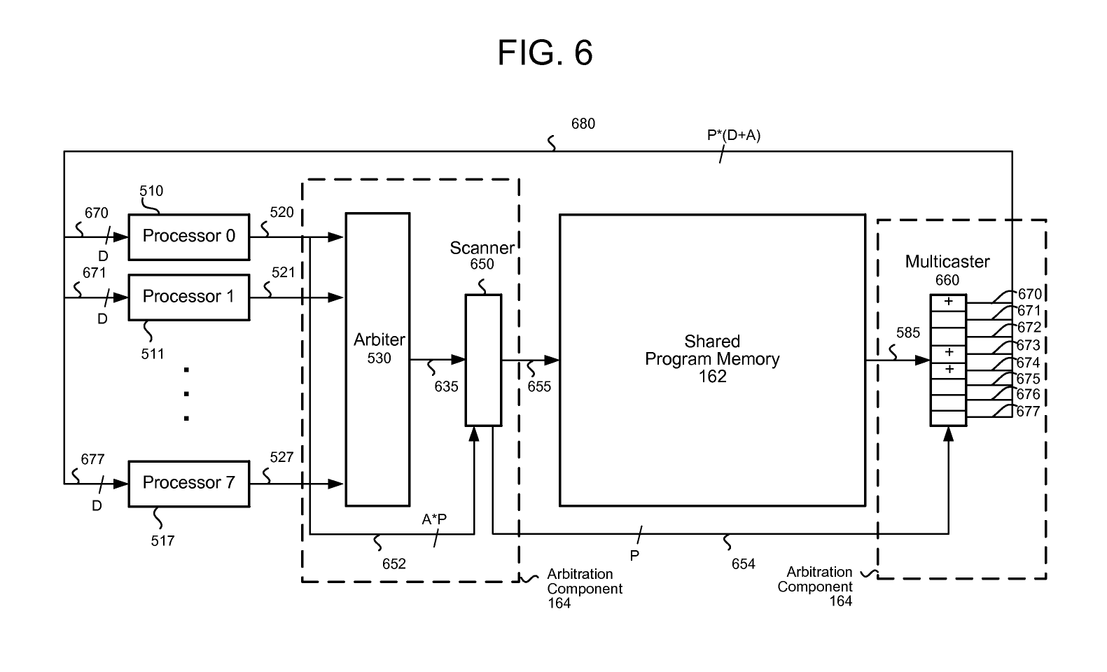

In another example, shown in FIG. 6, the arbitration component 164 may include an arbiter 530, a scanner 650 and a multicaster 660. Although not illustrated in FIG. 6, the configuration may also include the request valid bit lines (560-567), the acknowledgement lines (550-557, 570), the output valid bit lines (540-547), a pipeline circuitry, delay circuitry, as well as other components. In the configuration of FIG. 6, the arbiter 530 determines which processor's request will be selected for purposes of accessing the memory. The address corresponding to the selected processor will then be sent across line 635 to the scanner 650. The scanner 650 will then send that requested address to the shared program memory 162 on line 655. The scanner 650 will also receive the addresses requested by each of the processors 510-517 over address lines 652, where 652 represents a set of P address lines, where P corresponds to the number of processors and A corresponds to the number of address bits of the system. The scanner 650 will then compare the addresses indicated on lines 652 with the address indicated on line 635. For each processor whose requested address matches the priority address from the arbiter 530 (i.e., on line 635), the scanner may set a corresponding bit on indicator line 654 which connects to multicaster 660. Each bit of indicator line 654 corresponds to a processor. Thus, the scanner 650 can indicate to the multicaster 660, which processor is requesting the data output from the shared program memory 162. Thus, for example, if processors 0, 3, and 4 are all requesting to access the same memory address that is currently being output by the shared program memory 162, bits 0, 3 and 4 of line 654 may be set by the scanner. The scanner 650 and multicaster 660 are configured to work with pipeline/delay circuitry to ensure that the appropriate bits on line 654 are set so that the data output from the shared program memory 162 is sent to the appropriate requesting processors.

The multicaster 660 is connected to multiple data busses 670-677, each connected to the input of a respective processor. Each data bus has D lines representing the number of lines needed to communicate data. The collective P data (one for each processor) busses may be represented by line 680. The multicaster 660 receives the output data from the shared program memory on data bus 585. The multicaster 660 then activates the data bus(ses) corresponding to the processors requesting data from the accessed memory location. Thus, for example, if processors 0, 3, and 4 are all requesting to access the same memory address that is currently being output by the shared program memory 162, the multicaster 660 will send the data received on bus 585 to busses 670, 673, and 674. That data will then be received, respectively, by processor 0 510, processor 3, 513, and processor 4 514. (Though, as noted above, certain timing circuitry may be implemented to ensure that the data output onto lines 670, 673, and 674 at a time when the respective processors are notified that the requested data is available.) As can be appreciated, the data resulting from the requested address is thus broadcasted to the processors so that the processors receive the data substantially simultaneously, thus significantly reducing the delays found in the prior art discussed above.

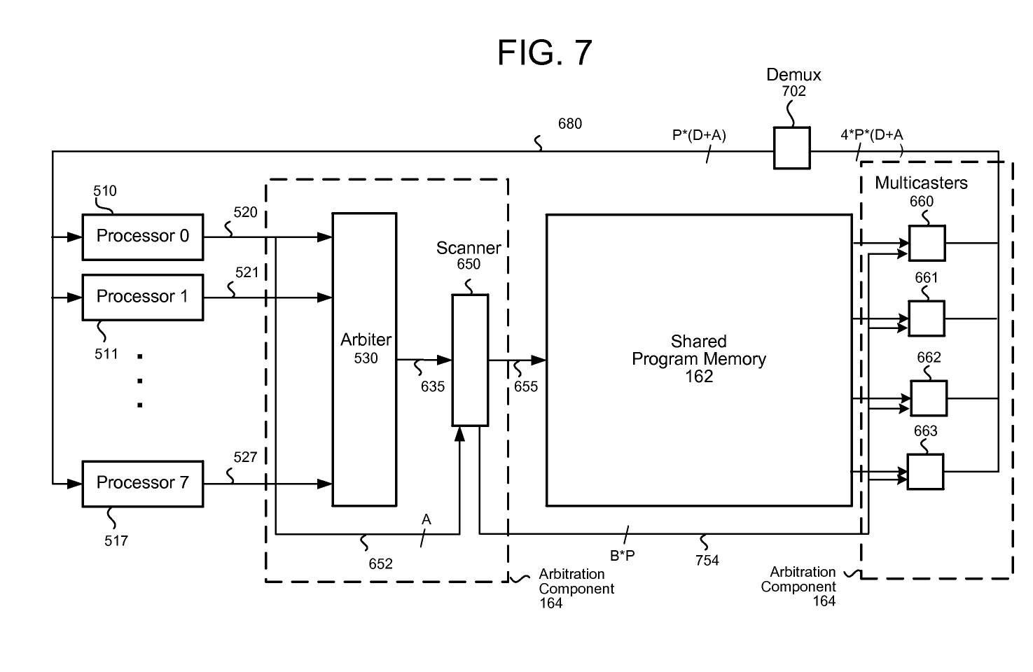

Another implementation for distributing data from the shared program memory 162 to the processors is shown in FIG. 7. As illustrated in FIG. 7, the system may include a plurality of multicasters (660-663). Such a configuration may be used in a configuration that allows queueing of requested memory addresses, either by the processors 510-517, or by the memory 162, or otherwise. In such as situation, the scanner 650 may indicate individually to a multicaster (across lines 754) which processors are requesting a particular address for the particular multicaster. This indication may be made across line 754 which may be P*B lines (i.e., P lines for each multicaster) or may simply be P lines, where each multicaster is told when to access lines 754 for purposes of data distribution. An individual multicaster will activate when the data corresponding to that multicaster is output by the memory. Various timing/delay circuitry (not shown) may be used to coordinate distribution of the appropriate data from the memory by the individual multicasters.

For example, if each processor is capable of buffering four input requests, the first input request of each processor may be compared against each other and the bits for the processors that match be set for multicaster 660. A state machine or other configuration may be used for a processor to determine when a read request has been accepted by the arbitration component 164 and/or arbiter 650 and when a next request is to be generated. Similarly, the second input request of each processor may be compared against each other and the bits for the processors that match be set for multicaster 661. Same for the third input request of each processor and multicaster 662, and the fourth input request for each processor and multicaster 663. For each queued input request the scanner 650 (or other comparator) may indicate to the arbiter 530 (or other component) which address request is duplicated across processors (or a processor that is requesting the duplicated address) for each respective queued input so the arbiter 530 can select the appropriate address corresponding to each queued input/multicaster.

Configuring multiple multicasters using the configuration of FIG. 7 (or other configuration) may allow faster distribution of data from the memory 162 to the processors 510-517 by allowing different broadcast masks to be queued and ready to output their respective data when the data is output from the memory 162. The different multicasters of FIG. 7 may each be configured with regard to a different tile of shared memory 162 (where memory tiles may be arranged and operate as discussed above in reference to FIG. 4A). Thus, the configuration of FIG. 7 may function to allow a multicaster to work with an individual tile (along with other tile-specific circuitry, such as a request pipeline, etc.) and to distribute data from a specific tile to the requesting processor. As also shown in FIG. 7, a de-multiplexer (demux) 702 may be used to select which multicaster's output to put on the data bus 680. The demux 702, multicasters 660-663, scanner 650, and/or processors 510-517 may all be connected through one or more connections (not shown) that control timing of input/output/masks to ensure the proper data is sent to the proper processor(s) at the proper time. The demux 702 may be incorporated into the arbitration component 164, depending on system configuration. Similarly, the various lines, delay circuitry, etc.

FIG. 8 illustrates a process for allowing multiple processor access to shared program memory according to one aspect of the present disclosure. Although illustrated as a sequence of steps, certain steps may be performed in a different order than illustrated, or in parallel with other illustrated steps. As shown, the system may determine (802) a first address from a first processor. The system may compare (804) the first address to requested addresses from other processors to determine if any of the other processors are also requesting data from the first address. The system may then set (806) indicator bit(s) corresponding to the processor(s) requesting the first address. The system also send (808) the first address to a memory. The system may retrieve (810) data corresponding to the first address and may send (812) the data to the first processor and any other processor(s) requesting data from the first address, as indicated by the indicator bit(s). The system may deliver the data to the processors substantially simultaneously, i.e., within the same or a few clock cycles.

For example, an arbitration component (which may include an arbiter 530, scanner 650, multicaster 660 and/or other component) may receive an indication over a first request valid bit line (e.g., line 560) an indication that a first processor (e.g., processor 510) is requesting data from memory. The arbitration component may also receive an indication over a second request valid bit line (e.g., line 561) an indication that a second processor (e.g., processor 511) is requesting data from memory. The arbitration component may receive a first address output by the first processor (e.g., processor 510) on a first address line (e.g., address line 520/652). The arbitration component may also receive a second address output by a second processor (e.g., processor 511) on a second address line (e.g., address line 521/652). The arbitration component may compare the first address to the second address and may determine that they are the same, namely that the first address and second address include the same first address. The arbitration component may then send the first address to the shared memory 162, for example on line 575/655. The shared program memory 162 may then output the data (e.g., a program instruction) corresponding to the first address on the data bus (585). The shared program memory 162 may acknowledge the request on acknowledgement line 570, which may include an active bit, or multiple bits to indicate to the arbiter which request is currently being handled.

Further, if used, a multicaster 660 may output the data corresponding to the first address on one or more data busses corresponding to the first processor and second processor. For example, the multicaster 660 may output the data onto a first data bus 670 corresponding to/connected to the first processor 510 and a second data bus 671 corresponding to/connected to the second processor 511.

The arbitration component may then set as active a first output valid bit line (e.g., 540) and a second output valid bit line (e.g., 541) (and/or other output valid bit lines) corresponding to the processors requesting data from the address being access by the memory 162. The first processor 510 and second processor 511 may then access the data on the connected data bus (585/670/671) in response to the corresponding output valid bit line being set as active.

In certain embodiments, a comparator or other circuitry may be configured to receive new read requests from processors and compare them to a memory address that is already in progress. If any of the new read requests match the address of a memory location currently being accessed, the comparator may update output valid bit lines (e.g., 540-547, 654, 754, or the like) to include the processor corresponding to the new read request. For example, if a first shared memory access event results in processors 0, 3, and 4 all requesting data from the same memory address, bits corresponding to those processors would be ready to be set when the data from the same memory address is output from the shared program memory 162. However, because the read operation may take multiple clock cycles, if, while the memory is being accessed, processor 1 indicates a new read request from the same memory address, the comparator may update the output valid bits (while the memory is being accessed) so that processor 1 is also given access to the data from the shared memory corresponding to the same memory address. In this manner, processors that are “late” by a few clock cycles in requesting data from a same memory location may still get the data from that location without having to engage a further memory retrieve operation.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, microprocessor design, and network architectures should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

As used in this disclosure, the term “a” or “one” may include one or more items unless specifically stated otherwise. Further, the phrase “based on” is intended to mean “based at least in part on” unless specifically stated otherwise.

What is claimed is:

1. A semiconductor chip comprising:
a shared memory storing instructions operable by a processor core;
a plurality of processing elements, each processing element comprising:
a processor core,
a data input, and
an address output;
at least one arbitration component connected to:
the address output of each of the plurality of processing elements, and
a plurality of output valid bit lines, each output valid bit line corresponding to one of the plurality of processing elements,
wherein the at least one arbitration component is configured to:
compare the respective address outputs to determine matching requested address locations output from the plurality of processing elements,
output a memory address to the shared memory, and
set output valid bit lines for the respective processing elements that requested data from the memory address; and
at least one data bus connecting an output of the shared memory to the data input of each of the plurality of processing elements.

2. The semiconductor chip of claim 1, wherein the at least one arbitration component is further configured to:
receive a first address from a first address output of a first processing element of the plurality of processing elements;
receive the first address from a second address output of a second processing element of the plurality of processing elements;
determine that the first address output and second address output include the same first address;
send the first address to the shared memory; and
set a first output valid bit line corresponding to the first processing element and set the second output valid bit line corresponding to the second processing element.

3. The semiconductor chip of claim 2, wherein:
the at least one data bus is a shared data bus;
each processing element is connected to a respective output valid bit line; and
the first output valid bit line and second output valid bit line are set at a time corresponding to a time at which the shared memory outputs data corresponding to the first address to the shared data bus.

4. The semiconductor chip of claim 2, wherein the at least one arbitration component comprises a multicaster and the multicaster is:
connected to the output valid bit lines;
connected to the output of the shared memory; and
connected to a plurality of data bus lines, each data bus line connected to a data input of a processing element of the plurality of processing elements,
wherein the multicaster is configured to:
in response to the first output valid bit line being set, output first data corresponding to the output of the shared memory to a first data bus line, the first data bus line connected to the first processing element and corresponding to the first output valid bit line; and
in response to the second output valid bit line being set, output the first data to a second data bus line, the second data bus line connected to the second processing element and corresponding to the second output valid bit line.

5. The semiconductor chip of claim 4, wherein the outputting the first data onto the first data bus line and outputting the first data onto the second data bus line occurs within a same clock cycle.

6. The semiconductor chip of claim 1, wherein the at least one arbitration component is further configured to:
in response to the first output valid bit line being set, set an acknowledgement bit connected to the first processing element; and
in response to the second output valid bit line being set, set an acknowledgement bit connected to the second processing element.

7. The semiconductor chip of claim 1, further comprising an address line connecting an output of the shared memory to each of the plurality of processing elements.

8. A method comprising:
loading a first memory address from a first processing element;
loading a second memory address from a second processing element;
determining that the first memory address and second memory address are the same;
sending the first memory address to a memory component;
outputting, from the memory component, first data stored at a location within the memory component corresponding to the first memory address; and
sending, within a first clock cycle, the first data to the first processing element and to the second processing element.

9. The method of claim 8, further comprising, prior to sending the first data:
setting a first output valid bit line corresponding to the first processing element; and
setting a second output valid bit line corresponding to the second processing element.

10. The method of claim 9, further comprising:
based on the first output valid bit line being set, sending the data to the first processing element using a first data bus; and
based on the second output valid bit line being set, sending the data to the second processing element using a second data bus.

11. The method of claim 8, wherein the first data is sent on a shared data bus to the first processing element and to the second processing element.

12. The method of claim 8, further comprising:
in response to the first output valid bit line being set, set an acknowledgement bit connected to the first processing element; and
in response to the second output valid bit line being set, set an acknowledgement bit connected to the second processing element.

13. The method of claim 8, wherein the loading and determining are performed by at least one arbitration component.

14. The method of claim 8, further comprising sending, to the first processing element and to the second processing element, the first memory address at a same time as the first data.

15. A system configured for:
loading a first memory address from a first processing element;
loading a second memory address from a second processing element;
determining that the first memory address and second memory address are the same;
sending the first memory address to a memory component;
outputting, from the memory component, first data stored at a location within the memory component corresponding to the first memory address; and
sending, within a first clock cycle, the first data to the first processing element and to the second processing element.

16. The system of claim 15, further configured for, prior to sending the first data:
setting a first output valid bit line corresponding to the first processing element; and
setting a second output valid bit line corresponding to the second processing element.

17. The system of claim 16, further configured for:
based on the first output valid bit line being set, sending the data to the first processing element using a first data bus; and
based on the second output valid bit line being set, sending the data to the second processing element using a second data bus.

18. The system of claim 15, wherein the first data is sent on a shared data bus to the first processing element and to the second processing element.

19. The system of claim 15, configured for:
in response to the first output valid bit line being set, set an acknowledgement bit connected to the first processing element; and
in response to the second output valid bit line being set, set an acknowledgement bit connected to the second processing element.

20. The system of claim 15, wherein the loading and determining are performed by at least one arbitration component.

21. The system of claim 15, configured for sending, to the first processing element and to the second processing element, the first memory address at a same time as the first data.
